(19) United States
(12) Patent Application Publication
(10) Pub. No.: US 2003/0016323 A1
(43) Pub. Date: Jan. 23, 2003

(54) Reflective display and information appliance

(76) Inventors: Masaaki Ikeda, Kyoto-shi (JP); Akihiro Funamoto, Kyoto-shi (JP); Shigeru Aoyama, Kyoto-shi (JP)

Correspondence Address: ROSENTHAL & OSHA L.L.P., Suite 2800, 1221 McKinney Street, Houston, TX, 77010, US

(21) Appl. No.: 10/194,847

(22) Filed: Jul. 12, 2002

(30) Foreign Application Priority Data
Jul. 19, 2001 (JP) 219301/2001

(51) Int. Cl. G02F 1/1335

(52) U.S. Cl. 349/113

(57) ABSTRACT

To prevent decline of visibility due to fluctuation in the number of unit reflection regions in a reflective display. In a reflective display comprising a liquid crystal display, and a reflective plate for reflecting the light passing through the liquid crystal display, the liquid crystal display has plural openings, the reflective plate has plural unit reflection regions, and the array pitch r of the unit reflection regions and the array pitch p of the openings of the display satisfy the relation of r=p/m (where m is a natural number).

### BACKGROUND OF THE INVENTION

1. Field of the Invention

The present invention relates to a technology for enhancing the display image quality in a reflective display using a liquid crystal display.

2. Description of the Related Art

Recently, as the liquid crystal displays are applied widely in personal computers, television receivers, word processors, video cameras, and others, these appliances are more and more demanded to be smaller in size, lower in cost, and higher in function. To meet such needs, reflective displays capable of displaying by reflecting the ambient light entering from outside without using backlight are being developed.

A principle of such reflective display is shown in FIG. 1. FIG. 1 is a schematic sectional view of a reflective display. This reflective display has a reflective plate 21 disposed at the back side of a liquid crystal display 20, and when external light such as sunlight enters the liquid crystal display 20, the incident light passes through pixels in the liquid crystal display 20, and is reflected by the reflective plate 21, and is emitted to the front face through the liquid crystal display 20. At this time, by controlling the liquid crystal display 20 so as to pass or shield the light in every pixel, an image is created in the liquid crystal display 20.

In such reflective display, since back light is not used, it is important how to brighten the display panel by utilizing the ambient light efficiently. For this purpose, the reflective plate 21 installed in the reflective display plays a major role, and it has been considered indispensable to develop a technology for designing the reflective plate 21 having optimum reflection characteristics by efficiently making use of the ambient light entering from all angles.

In the reflective display, incidentally, since the liquid crystal display 20 and reflective plate 21 are combined, glare of the reflected light on the surface of the liquid crystal display 20 causes a serious problem. That is, when external light such as sunlight enters the liquid crystal display 20, all incident light does not passes through the liquid crystal display 20, but part of the light is reflected by the surface of the liquid crystal display 20. As a result, as shown in FIG. 2, the emitted light reflected by the reflective plate 21 and emitted from the liquid crystal display 20, and the reflected light of normal reflection from the surface of the liquid crystal display 20 are emitted in the same direction, and the light source is glared in the image, and the visual recognition is lowered.

To solve the problem, hitherto, a reflective plate forming plural unit reflection regions on the surface is used. Unit reflection regions include a prism pattern as shown in FIG. 3, multiple spherical bumps as shown in FIG. 4, and multiple columnar, pyramidal, or conical bumps. Although not shown, aside from individual protruding shapes, reflection regions fulfilling the function by composing plural bumps or rugged shapes are also called unit reflection regions. When plural unit reflection regions are provided in the reflective plate, as shown in FIG. 5, the light passing through the liquid crystal display is scattered in the unit reflection regions when reflected by the reflective plate. Accordingly, the emitted light emitted from the liquid crystal display 20 is emitted also in a direction different from the reflected light of normal reflection on the surface of the liquid crystal display 20, and the image can be observed without being disturbed by the reflected light, and the visibility is improved.

However, when unit reflection regions are formed by arraying in periodic stripe or lattice as shown in FIG. 2 or FIG. 3, a slight spatial frequency difference occurs between the reproduction by the unit reflection regions and the pixels of the liquid crystal display 20 formed in periodic lattice, and moire pattern is formed, and the display image of the liquid crystal display 20 is lowered. Accordingly, in the reflective plate having unit reflection regions as shown in FIG. 6, for example, spherical bumps are arrayed at random so as not to be periodic. This reflective plate 21 reduces moire pattern by such aperiodic array of unit reflection regions, and improves the image quality.

In the reflective display, the display panel is brightened by using the ambient light, but when used in dark environments such as in a night time, illumination is needed. Since the reflectivity to the light entering from the surface of the liquid crystal display 20 is raised in the reflective display, the display panel can be efficiently brightened by using the front light.

When using the reflective plate arraying unit reflection regions at random in order to reduce the image quality deterioration due to moire pattern, the number of unit reflection regions in pixel pitch of the liquid crystal display varies depending on the size of individual unit reflection regions. Such variation in the number of unit reflection regions may cause difference in the quantity of light reflected between pixels, which may lead to fluctuation of brightness of pixels. Such fluctuation of brightness is superposed on the image in the liquid crystal display depending on the pixel frequency, and thereby the image becomes rough and the visibility is lowered.

Or if fluctuation occurs in the pitch of the color filter opening of the liquid crystal display depending on the size of unit reflection regions, it results in difference in quantity of light that can be reflected among openings of each color, and fluctuation occurs in the brightness of openings or reproduction of color. Due to this fluctuation, uneven colors occur, and uneven colors are superposed on the image of the liquid crystal display, and thereby the image becomes rough and the visibility is lowered.

When using the front light, in order to utilize the ambient light of a wide light incident angle and the illuminating light from the front light of a nearly constant incident angle efficiently, it was necessary to form two kinds of unit reflection regions for emitting each light in a specified direction. To reduce image quality deterioration due to moire pattern, when two kinds of unit reflection regions are arrayed at random, fluctuation occurs in the number of unit reflection regions in the pixels of the liquid crystal display or in the openings of the color filter. This fluctuation in the number of unit reflection regions becomes different in the quantity of light that can be reflected, which may lead to fluctuation in the brightness of the pixels or color filter. Such fluctuation in brightness or fluctuation in color reproduction is superposed on the image in the liquid crystal display depending on the pixel frequency, and thereby the image becomes rough and the visibility is lowered.

### SUMMARY OF THE INVENTION

The reflective display of the invention is a reflective display comprising a liquid crystal display, and a reflective plate for reflecting the light passing through the liquid crystal display, in which the liquid crystal display has plural openings, the reflective plate has plural unit reflection regions, and the array pitch r of the unit reflection regions and the array pitch p of the openings satisfy the relation of

r=p/m (where m is a natural number of 2 or more).

In other aspect, the reflective display of the invention is a reflective display comprising a liquid crystal display, a front light disposed ahead of the liquid crystal display for emitting light to the liquid crystal display, and a reflective plate for reflecting the light passing through the liquid crystal display, in which the liquid crystal display has plural openings, the reflective plate has a plurality of first unit reflection regions reflecting the ambient light passing through the front light and liquid crystal display in a specified direction, and second unit reflection regions for reflecting the illuminating light emitted from the front light and passing through the liquid crystal display in a specified direction, and the array pitches s1, s2 of the first and second unit reflection regions and the opening pitch p of the liquid crystal display satisfy the relations of

s1=p/n1

s2=p/n2 (where n1, n2 are natural numbers of 2 or more)

Preferably, in the reflective display of the invention, the openings are pixels of the image formed by the liquid crystal display.

Preferably, in the reflective display of the invention, the liquid crystal display has a color filter formed of display regions for plural colors, and the openings are monochromatic openings of the color filter.

Preferably, in the reflective display of the invention, the liquid crystal display has a black matrix unit, and regions not forming unit reflection regions are disposed in the regions on the reflective plate shielded by the black matrix unit.

Preferably, in the reflective display of the invention, the range of forming the unit reflection regions is limited by the unit reflection regions so that the light entering from a specified opening may be emitted only from the same opening.

The information appliance of the invention is an information appliance using a reflective display comprising a liquid crystal display having plural openings, and a reflective plate having plural unit reflection regions for reflecting the light passing through the liquid crystal display, in which the array pitch r of the unit reflection regions and the array pitch p of the openings satisfy the relation of

r=p/m (where m is a natural number of 2 or more).

In other aspect, the information appliance of the invention is an information appliance using a reflective display comprising a liquid crystal display having plural openings, a front light disposed ahead of the liquid crystal display for emitting light to the liquid crystal display, and a reflective plate having a plurality of first unit reflection regions and second unit reflection regions each for reflecting the light passing through the liquid crystal display, in which the array pitches s1, s2 of the unit reflection regions and the array pitch p of the openings satisfy the relations of

s1=p/n1

s2=p/n2 (where n1, n2 are natural numbers of 2 or more)

Preferred examples of the information appliance of the invention include mobile phone, portable information terminal, personal computer, video camera, and television receiver.

The liquid crystal display method of the invention is a liquid crystal display method using a reflective display comprising a liquid crystal display having plural openings, and a reflective plate having plural unit reflection regions, in which the array pitch r of the unit reflection regions and the array pitch p of the openings satisfy the relation of

r=p/m (where m is a natural number of 2 or more), and an image is created by reflecting the light entering from the liquid crystal display by the unit reflection regions, and emitting to the front face from the liquid crystal display.

In other aspect, the liquid crystal display method of the invention is a liquid crystal display method using a reflective display comprising a liquid crystal display having plural openings, a front light disposed ahead of the liquid crystal display for emitting light to the liquid crystal display, and a reflective plate having a plurality of first unit reflection regions and second unit reflection regions each, in which the array pitches s1, s2 of the unit reflection regions and the opening pitch p of the liquid crystal display satisfy the relations of

s1=p/n1

s2=p/n2 (where n1, n2 are natural numbers of 2 or more),

and an image is created by reflecting the external light and the light from the lighting device in specified directions each by the first unit reflection regions and second unit reflection regions, and emitting to the front face from the liquid crystal display.

According to the invention, in the reflective display comprising a liquid crystal display, and a reflective plate for reflecting the light passing through the liquid crystal display, the liquid crystal display has plural openings, the reflective plate has plural unit reflection regions, and the array pitch r of the unit reflection regions and the array pitch p of the openings satisfy the relation of

r=p/m (where m is a natural number of 2 or more),

and therefore the number of unit reflection regions disposed beneath each opening of the liquid crystal display is nearly constant. As a result, the quantity of reflected light in each opening is uniform, and an image free from roughness is obtained.

Further according to the invention, in the reflective display comprising a liquid crystal display, a front light disposed ahead of the liquid crystal display for emitting light to the liquid crystal display, and a reflective plate for reflecting the light passing through the liquid crystal display, the liquid crystal display has plural openings, the reflective plate has a first unit reflection region reflecting the ambient light passing through the front light and liquid crystal display in a specified direction, and a second unit reflection region for reflecting the illuminating light emitted from the front light and passing through the liquid crystal display in a specified direction, and the array pitches s1, s2 of the first and second unit reflection regions and the opening pitch p of the liquid crystal display satisfy the relations of

s1=p/n1

s2=p/n2 (where n1, n2 are natural numbers of 2 or more),

and therefore the number of unit reflection regions disposed beneath each opening of the liquid crystal display is nearly constant. As a result, the quantity of reflected light in each opening is uniform, and an image free from roughness is obtained.

Further according to the invention, the openings of the reflective display are pixels of the image formed by the liquid crystal display, and therefore the quantity of reflected light in each pixel is uniform, and an image free from roughness is obtained.

Further according to the invention, the openings of the reflective display are monochromatic openings of the color filter formed of display regions for plural colors, and therefore the quantity of reflected light in each monochromatic opening is uniform, and an image free from roughness is obtained. Moreover, the color reproduction of each monochromatic opening is uniform, and roughness due to uneven colors or fluctuation in color reproduction can be prevented.

Further according to the invention, by forming regions free from unit reflection regions in the shaded region covered with a black matrix unit, the number of unit reflection regions beneath the openings can be adjusted spatially. Therefore, it solves the problem that the width of the shaded region is not always a multiple of a natural number of the array pitch r of the unit reflection regions.

Further according to the invention, by limiting the range of forming the unit reflection regions, so that the light entering from a specified opening maybe emitted only from the same opening only, it can lessen roughness due to uneven brightness, or uneven colors or roughness due to inaccurate color reproduction. That is, it solves the problem that the quantity of light emitted from the specified opening varies due to the light from an adjacent opening, thereby not obtaining specified brightness accurately. Or when the opening is a color filter, mixing of colors is prevented due to light entering from an adjacent color filter, so that the precision of color reproduction may be enhanced.

The information appliances employing the reflective display of the invention, such as mobile phone, portable information terminal, mobile personal computer, video camera, or television can present images free from roughness.

Also the liquid crystal display method using the reflective display of the invention can present images free from roughness.

### BRIEF DESCRIPTION OF THE DRAWINGS

FIG. 1 shows a principle of a reflective display (1).

FIG. 2 shows problems of the prior art.

FIG. 3 shows unit reflection regions by prism pattern.

FIG. 4 shows unit reflection regions by spherical bumps.

FIG. 5 shows effects of scattering by unit reflection regions.

FIG. 6 shows a reflective plate with aperiodic unit reflection regions.

FIG. 7 shows a principle of a reflective display (2).

FIG. 8 shows a principle of a reflective display (3).

FIG. 9 shows a configuration of a reflective display according to a first embodiment of the invention.

FIG. 10 shows a configuration of a reflective display according to a second embodiment of the invention.

FIG. 11 shows a configuration of a reflective display according to a third embodiment of the invention.

FIG. 12 shows a configuration of a reflective display according to a fourth embodiment of the invention.

FIG. 13 shows a configuration of a reflective display according to a fifth embodiment of the invention.

FIG. 14 shows a configuration of a reflective display according to a sixth embodiment of the invention.

FIG. 15 schematically shows a mobile phone employing any one of the embodiments of the invention.

FIG. 16 schematically shows a portable information terminal employing any one of the embodiments of the invention.

FIG. 17 schematically shows a mobile computer employing any one of the embodiments of the invention.

FIG. 18 schematically shows a television receiver employing any one of the embodiments of the invention.

FIG. 19 shows a list of shape examples of unit reflection regions.

### DESCRIPTION OF THE PREFERRED EMBODIMENTS

(Configuration and Manufacturing Method of Reflective Display)

Prior to description of embodiments, possible configurations of the liquid crystal display and reflective plate of the reflective display of the invention and individual forming methods are explained.

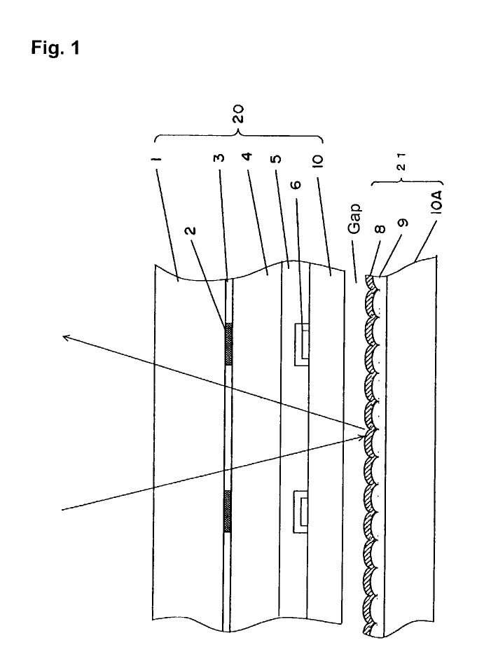

FIG. 1 is a partially cut-away schematic sectional view, showing a most typical configuration of a liquid crystal display 20 and a reflective plate 21. In this reflective display, the reflective plate 21 is formed as a separate part from the liquid crystal display 20. The base material of the reflective plate 21 is a plate of glass, ceramics, resin, or metal. Or a reflection sheet may be formed by using polyolefin or other resin sheet as the base material.

The forming method of the shape (base shape) of a base layer 9 of the unit reflection region is not shown, but is as follows. An ultraviolet ray curing resin is applied on a base material, a stamper is pressed on the ultraviolet ray curing resin, and the ultraviolet ray curing resin is pressed and spread widely between the base material and the stamper. An ultraviolet ray is emitted to the ultraviolet ray curing resin through the base material, and the ultraviolet ray curing resin is cured, and the base shape is formed by the cured ultraviolet ray curing resin. When the stamper is removed from the base shape, an rugged pattern is transferred on the surface of the base shape. On the surface of the base shape, a thin film of high reflectivity material such as Ag or Al is formed as a reflection plane by sputtering or vapor deposition method. On the surface of the reflection plane, an orientation film 5 for aligning the orientation of liquid crystal, flattening film, or insulating film is formed of polyimide resin or the like according to a type (kind of liquid crystal) of the liquid crystal display 20, so that a reflective plate 21 or a reflection sheet is formed.

In other forming method of the base shape, a transparent acrylic, polyimide or other resin is dissolved in a solvent, and is applied on the base material surface in a uniform thickness by spin coating or slit coating, and the solvent is heated and dried together with the base material by hot plate or oven to form a resin film, and a stamper is pressed on the resin film heated and softened together with the base material by hot plate, and a pattern is transferred.

In a different forming method of the base shape, the base material formed by directly processing the material such as resin, glass or metal is heated and softened, and a stamper is directly pressed on the base material, so that the base shape is formed. On the surface of the base shape, a thin film of high reflectivity material such as Ag or Al is formed by sputtering or vapor deposition method. In this embodiment, a polypropylene sheet of 100 μm in thickness is used as the base material, and by directly forming the sheet material surface, a base layer 9 is formed, and a thin film of Ag of about 2000 angstroms is formed by vacuum vapor deposition method. In this configuration, processing of the base layer 9 by calender forming, and forming of reflection film 8 by winding vapor deposition method are enabled, and an operation cycle of very high speed is realized. However, the material, shape and dimension are not limited to the shown examples.

In a further different forming method of the base shape, a stamper is pressed on a heated metal foil of Al or the like, and unit reflection regions are formed by compression molding, and by making use of the reflection characteristic of the metal foil itself, the reflection film 8 or reflection sheet is formed by omitting the reflection film. In this method, the manufacturing process is simplified, and the material cost is lowered.

When disposing the reflective plate 21 or reflection sheet on the back side of the liquid crystal display 20 as other part of the liquid crystal display 20, a gap may be formed between the reflection surface and the back side of the liquid crystal display, or the gap may be filled up with a transparent resin or the like to adhere. Or by coating the surface of the reflection sheet with a transparent resin or the like beforehand, and adhering to the back side of the liquid crystal display, handling of the reflection layer (a thin reflective plate) may be easier, and oxidation or degeneration or damage of the reflection film can be prevented. Further, not shown, when sheet materials of base layer 9 or substrate 10A are transparent, similar effects are obtained by disposing the substrate 10A to the back side of the liquid crystal display 20, and reflecting the light at the interface of the base layer 9 and the reflection film 8 coating the base layer 9. In this case, however, the shape of unit reflection regions of the base layer 9 to be formed must be an inverted shape of FIG. 1 as a matter of course.

When the reflective plate 21 is a separate material from the liquid crystal display 20, setting of the material or manufacturing process is not limited by the heat, pressure, chemicals, and others relating to the processing, yield, or operation reliability, with respect to the liquid crystal derive element 6 formed on the lower substrate 10, and therefore inexpensive materials and manufacturing process maybe employed. However, the materials, shape, dimensions, and processing method are not limited to the shown examples.

Other configuration of the reflective display is explained. In the configuration shown in FIG. 7, the reflective plate 21 is integrated on the lower substrate 10. This configuration is formed as follows. Same as in the configuration shown in FIG. 1, on a lower substrate 10 made of glass, metal, ceramics, resin, or the like, the shape (base shape) of a base layer 9 is formed by photosetting method by ultraviolet ray curing resin, heating, pressing and forming method on the resin film formed on the substrate, or forming method of the substrate surface. On the surface of the base shape, a thin film of high reflectivity material such as Al or Ag is formed as reflection film 8 by vacuum vapor deposition method, sputtering method, or the like. In succession, to flatten the ruggedness of the base shape, a flattening film 7 is formed of an insulating material such as polyimide resin, other resin, or glass material in paste. Liquid crystal drive elements 6 such as TFT and pixel electrode are formed on the substrate, and an orientation film 5 controlling the liquid crystal orientation serving also as insulating film is formed by using polyimide resin or the like.

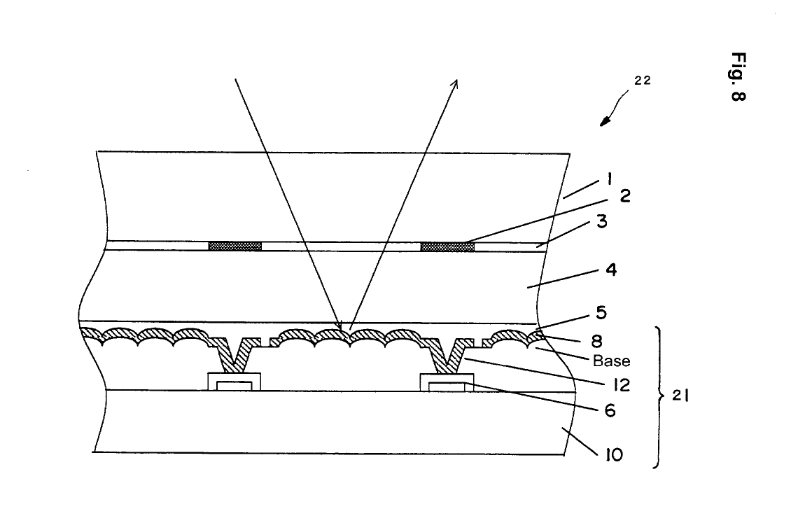

A different configuration of the reflective display is explained. In the configuration shown in FIG. 8, the reflective plate 21 is assembled in the lower substrate 10. In this reflective display, the reflection film 8 functions also as the pixel electrode. This configuration is formed as follows. On a lower substrate 10 preliminarily forming a liquid crystal drive element 9 such as TFT or pixel electrode, a base shape is formed by photosetting method by ultraviolet ray curing resin, heating, pressing and forming method on the resin film formed on the substrate, or forming method of the substrate surface. Alternatively, the base shape may be formed by photolithography. technology using photosensitive resin such as photo resist, or the base shape maybe heated and fused, and the base shape surface may be curved by surface tension. On the surface of the base shape, a thin film of high reflectivity material such as Al or Ag is formed as reflection film 8 by vacuum vapor deposition method, sputtering method, or the like. In succession, an orientation film 5 controlling the liquid crystal orientation is formed by using polyimide resin or other insulating material.

In this configuration, the reflection film 8 can also function as part of the liquid crystal drive element 6. By forming a contact hole portion 12 by photolithography technology using photosensitive resin such as photo resist, and forming the reflection film 8, conduction with the liquid crystal drive element 6 can be achieved. In this method, the base shape is formed by executing the heating, pressing and forming method of the photosensitive resin layer, or the photolithographic method before or after the contact hole forming process.

In the invention, the reflection film 8 is not limited to total reflection film, but may be a thin film controlled in film thickness or a semitransmission film by laminating plural materials. In this configuration, the light projected from the back light to the back of the liquid crystal display can be also emitted forward.

Three types of configuration of the liquid crystal display and reflection film are explained so far, but the configuration is not particularly limited as far as the reflective plate can be disposed at the back side of the liquid crystal layer and the optical path is not disturbed.

The configuration of the liquid crystal display 1 is schematically explained by referring to an example in FIG. 1. The liquid crystal display 20 comprises a liquid crystal drive element 6, a liquid crystal layer 4, and an opening 3 for color filter and pixel disposed between an upper substrate 1 and a lower substrate 10. Depending on the type of the liquid crystal, an orientation film 5 for controlling the orientation of the liquid crystal or an insulating film are further formed on the surface of the lower substrate 10. Further, a polarizer may be also overlaid.

(First Embodiment)

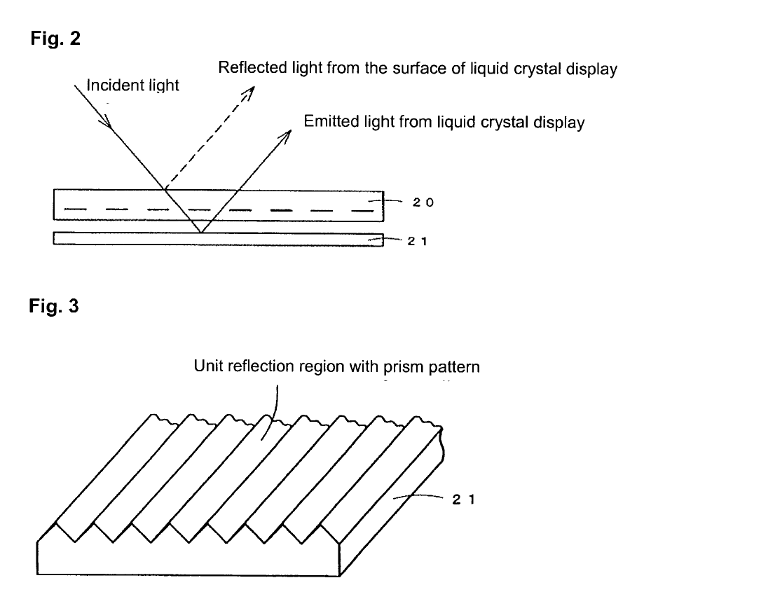

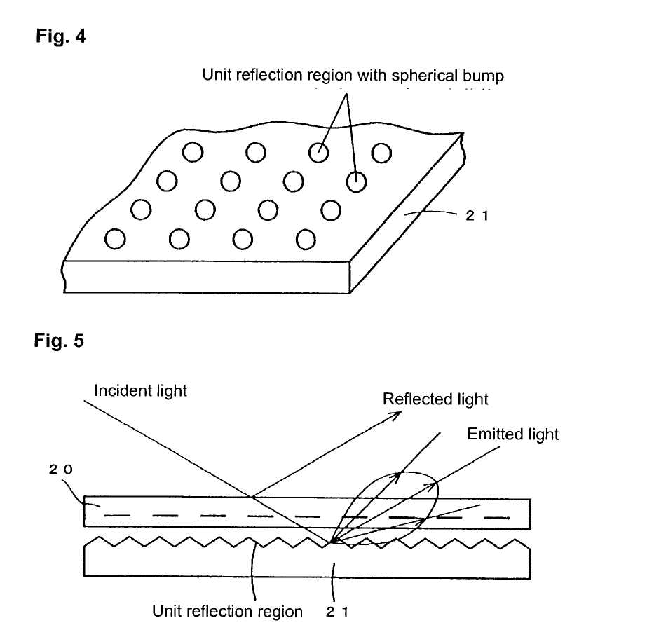

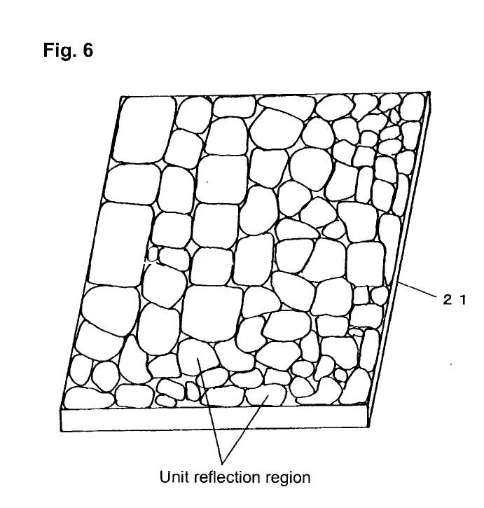

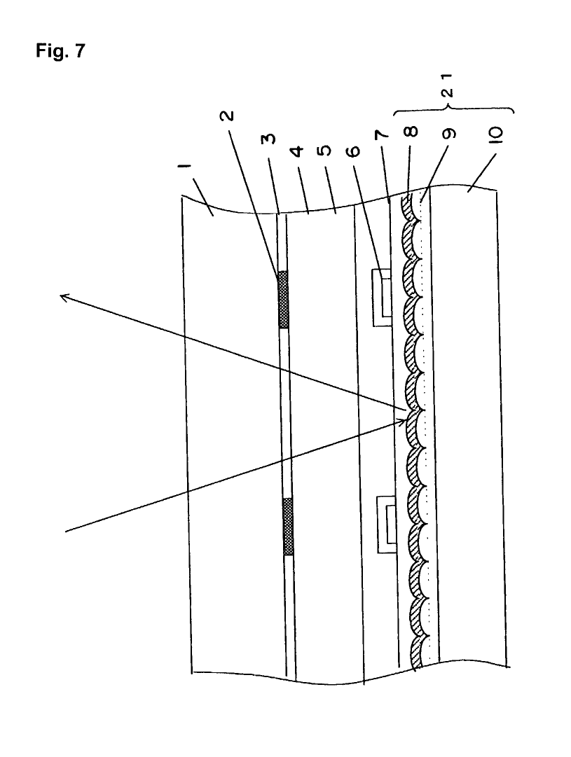

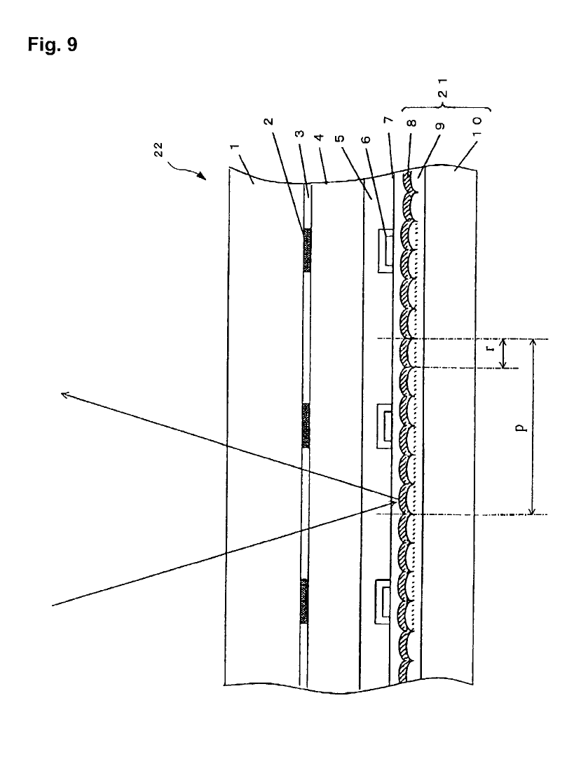

FIG. 9 shows an embodiment of the invention. Same constituent elements as explained in FIG. 1 to FIG. 8 are identified with same reference numerals, and their explanation is omitted.

In this embodiment, plural unit reflection regions for composing the reflective plate 21 are disposed so that the average array pitch r* and the pitch p of the opening 3 may satisfy the following formula:

r*=p/m (m is a natural number)

(in FIG. 9, m=6). According to this configuration, the number of unit reflection regions disposed beneath each opening 3 is almost uniform. Therefore, fluctuation of brightness of the openings 3 is reduced, and roughness of image is lessened, and the visibility is enhanced. In particular, according to the Nyquist theorem, in order to reproduce the spatial frequency 1/p of the opening 3 accurately, a spatial frequency of more than two times of the opening 3 is required. Therefore, by forming unit reflection regions at a spatial frequency of more than two times of the opening 3 and illuminating the opening 3, the image of the spatial frequency of the opening 3 can be reproduced accurately. However, unless the spatial frequency of the unit reflection regions is an integer multiple of the spatial frequency of the opening 3, a difference occurs between the spatial frequency reproduced by the unit reflection regions and the spatial frequency of the opening 3, which may cause moire pattern. Hence, the image can be reproduced correctly by defining m to be a natural number of 2 or more. In FIG. 8, unit reflection regions by one spherical bump are disposed by defining m to be 6, but the shape of the unit reflection regions, configuration of unit reflection regions, and the value of m are not limited to the shown examples alone.

Unit reflection regions are not limited to the conventional prism, spherical, columnar, pyramidal or conical bumps, but plural unit slopes modulated in the angle within the display panel may be arrayed in multiple rows, or aspherical curves may be composed. Or, by varying the shape and inclination angle of these unit reflection regions individually within the plane, it may be also composed to control the optical path, such as focusing or deviation of the reflection direction. Besides, the unit reflection regions may be formed of plural protruding shapes, and formed as regions having specified reflection functions.

(Second Embodiment)

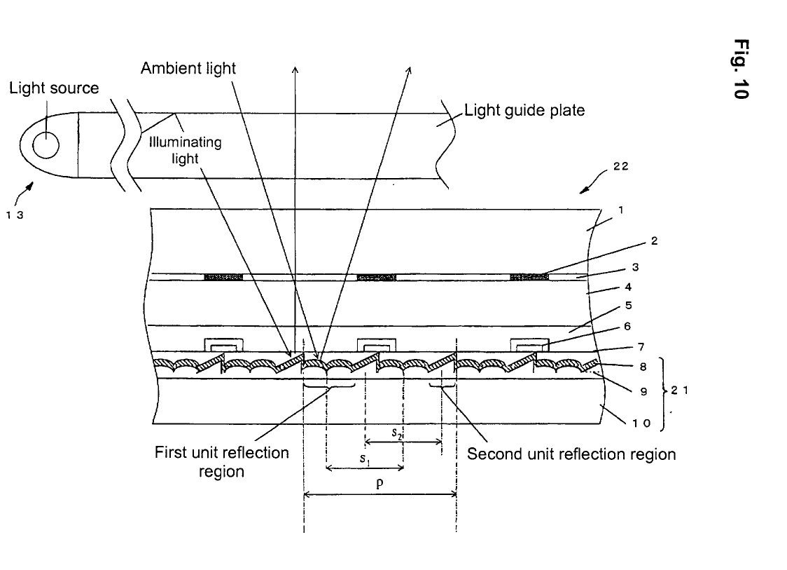

FIG. 10 shows other embodiment of the invention. This reflective display comprises a front light 13.

In this embodiment, different from the first embodiment, the reflective plate 21 has a plurality of first unit reflection regions reflecting the ambient light passing through the front light and liquid crystal display in a specified direction, and second unit reflection regions for reflecting the illuminating light emitted from the front light and passing through the liquid crystal display in a specified direction. The array pitches s1, s2 of the first and second unit reflection regions and the opening pitch p of the liquid crystal display satisfy the relations of

s1=p/n1

s2=p/n2 (where n1, n2 are natural numbers of 2 or more),

and therefore the number of unit reflection regions disposed beneath each opening is nearly constant. Therefore, fluctuation of brightness of the openings 3 obtained by each light is reduced, the roughness of image is lessened, and the visibility is improved. Same as in the first embodiment, according to the Nyquist theorem, the image can be reproduced accurately by defining n1 and n2 to be natural numbers of 2 or more. In FIG. 9, the first unit reflection regions by two spherical bumps, and second unit reflection regions by one bump with sawtooth section are shown in the example of n1 and n2 being 2 each, but the shape of the unit reflection regions, configuration of unit reflection regions, and the values of n1 and n2 are not limited to the shown examples alone.

Unit reflection regions are not limited to the conventional prism, spherical, columnar, pyramidal or conical bumps, but plural unit slopes modulated in the angle within the display panel may be arrayed in multiple rows, or aspherical curves may be composed. Or, by varying the shape and inclination angle of these unit reflection regions individually within the plane, it may be also composed to control the optical path, such as focusing or deviation of the reflection direction. Besides, the unit reflection regions may be formed of plural protruding shapes, and formed as regions having specified reflection functions.

The front light 13 at least comprises a light source unit of spot light source or linear light source such as LED or fluorescent lamp, and a light guide plate for guiding the light of the light source unit uniformly to the display panel of the liquid crystal display. The light guide plate is not limited to a flat light guide plate without rugged pattern as shown in FIG. 10, but may have a wedge shape, or may have an rugged pattern for light control on the surface.

(Third Embodiment)

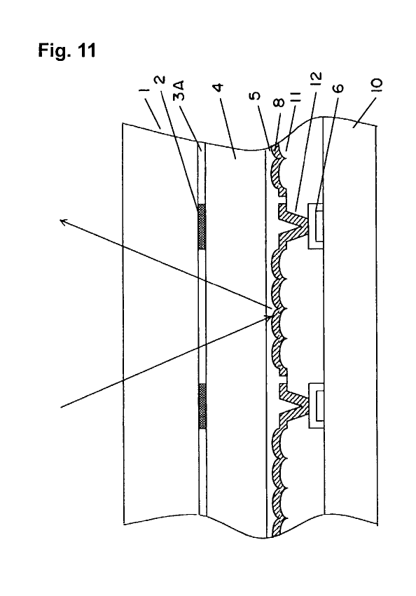

FIG. 11 shows a different embodiment of the invention.

In this embodiment, a pixel opening 3A is an opening for composing a pixel. This opening 3 is a passing area of light between black matrix units in monochromatic liquid crystal. In color liquid crystal, the pixel opening 3A corresponds to a set of three monochromatic openings for three primaries R, G, B of color filter.

In this embodiment, too, same as in the foregoing embodiments, the spatial frequency reproduced in the unit reflection regions is set at a natural number of 2 or more of the spatial frequency of the pixel.

In this configuration, the reflective display of the embodiment makes uniform the brightness of each pixel, and prevents roughness. This invention is particularly effective in the reflective display intended to display black and white image for controlling the transmissivity in the opening of the pixel ingradual steps, by driving the liquid crystal by stepwise signal drive of the liquid crystal drive element 6.

(Fourth Embodiment)

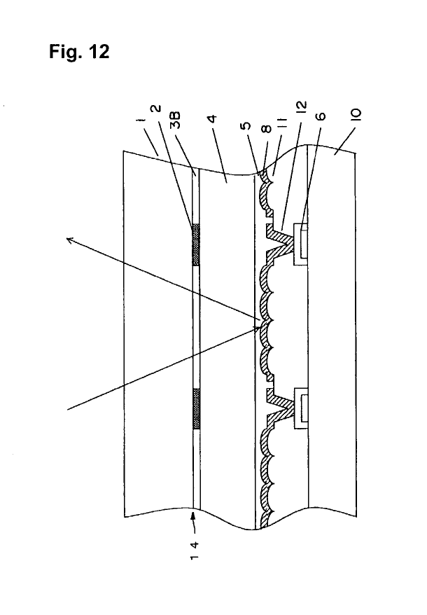

FIG. 12 shows a different embodiment of the invention.

In this embodiment, the reflective display has a color filter 14 including openings for plural colors. This color filter 14 has a monochromatic opening 3B between black matrix units 2.

In this embodiment, too, same as in the first and second embodiments, the spatial frequency reproduced in the unit reflection regions is set at a natural number of 2 or more of the spatial frequency of the pixel.

In this configuration, the reflective display of the embodiment makes uniform the brightness of each monochromatic opening 3B, and prevents roughness. Further, the color reproduction of each monochromatic opening 3B is enhanced, and occurrence of roughness due to fluctuation of color reproduction is prevented. This invention is particularly effective in the reflective display intended to reproduce plural colors by combining with adjacent monochromatic openings of other color and display color image by controlling the transmissivity in each monochromatic opening in gradual steps, by driving the liquid crystal by stepwise signal drive of the liquid crystal drive element 6.

(Fifth embodiment)

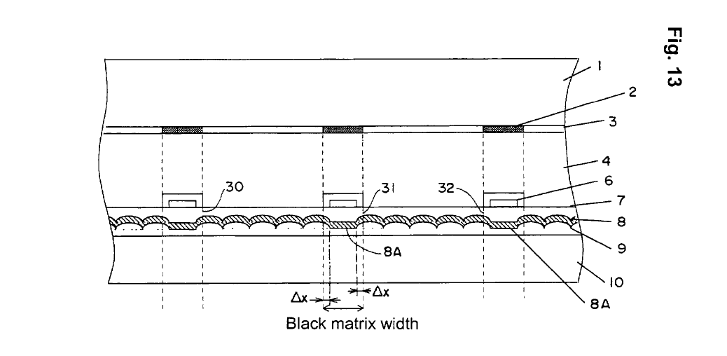

FIG. 13 shows a different embodiment of the invention.

The width of reflective plate region covered with black matrix unit 2 (shown as black matrix width in FIG. 13) is not always a natural number multiple of the unit reflection region pitch r.

In the reflective display of the embodiment, accordingly, unit reflection regions are not formed in part of the reflective plate region covered with black matrix unit 2 (regions 30, 31, 32, etc. in FIG. 13), and this area is used as an adjusting region for adjusting the number of deposition of unit reflection regions.

For example, in the region 31 covered with black matrix unit 2 in FIG. 13, unit reflection regions are formed only in the portion of the width indicated by Δx. In other area than this portion of the width of Δx, unit reflection regions are not formed. That is, range 8A is left over as an area free from unit reflection region.

Thus, in the reflective display of the embodiment, unit reflection regions are not formed partly in reflective plate regions 30, 31, 32, etc. covered with black matrix, and by adjusting spatially, the same number of unit reflection regions can be disposed in the pixel or color filter opening 3, so that the quantity of emitted light from the opening 3 can be made uniform.

Besides, to cope with the light entering obliquely from the opening 3, unit reflection regions may be partly provided in the reflective plate region 30, 31 or 32 covered with the black matrix unit 2. Therefore, the range not forming unit reflection regions maybe a range capable of adjusting spatially the region narrower than the black matrix width.

Although not shown, in the area not forming the unit reflection regions, rugged shape different from the unit reflection regions' shape may be formed, and a spacer for defining the gap amount of the liquid crystal layer 4, or a light diffusion plane with finer rugged shape may be formed.

(Sixth Embodiment)

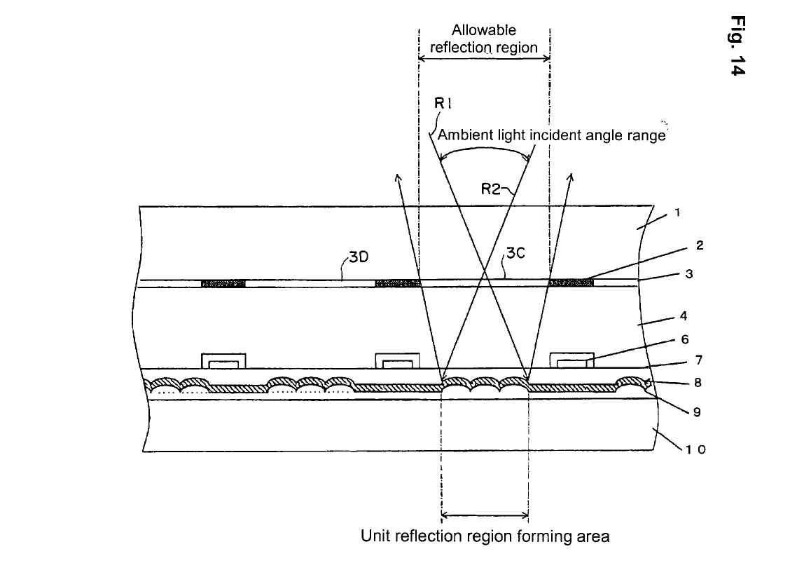

FIG. 14 shows a different embodiment of the invention.

In the reflective display of the embodiment, for example, unit reflection regions are limited and formed in the region immediately beneath the opening 3C. As a result, incident lights R1, R2 entering from the specified opening 3A are reflected in the unit reflection regions, and are emitted from the specified opening 3C.

Thus, by controlling the forming position of the unit reflection regions, for example, fluctuation of the quantity of light can be reduced by emitting the incident light from the opening 3C from the adjacent opening 3D. As a result, in this reflective display, roughness due to difference in brightness or inaccurate color reproduction can be suppressed.

When the opening 3C in FIG. 14 is formed as a monochromatic opening of color filter, emission of light entering from the color filter monochromatic opening to the adjacent color filter monochromatic opening can be prevented, so that color mixing of light can be prevented.

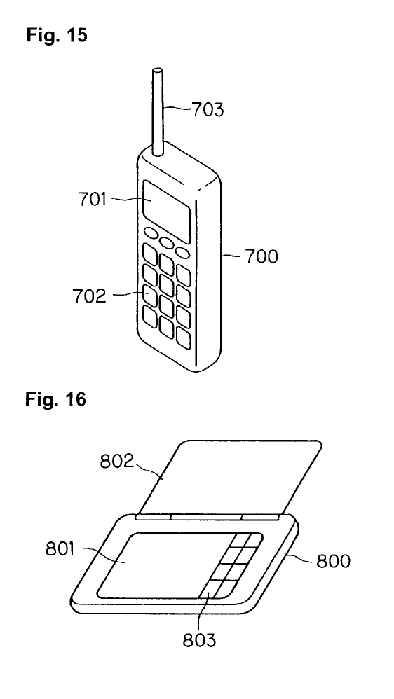

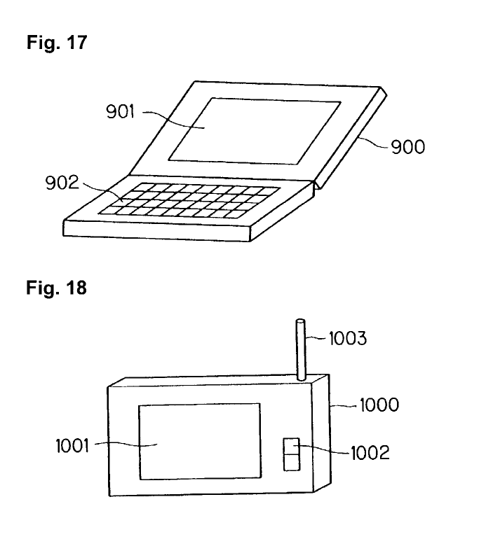

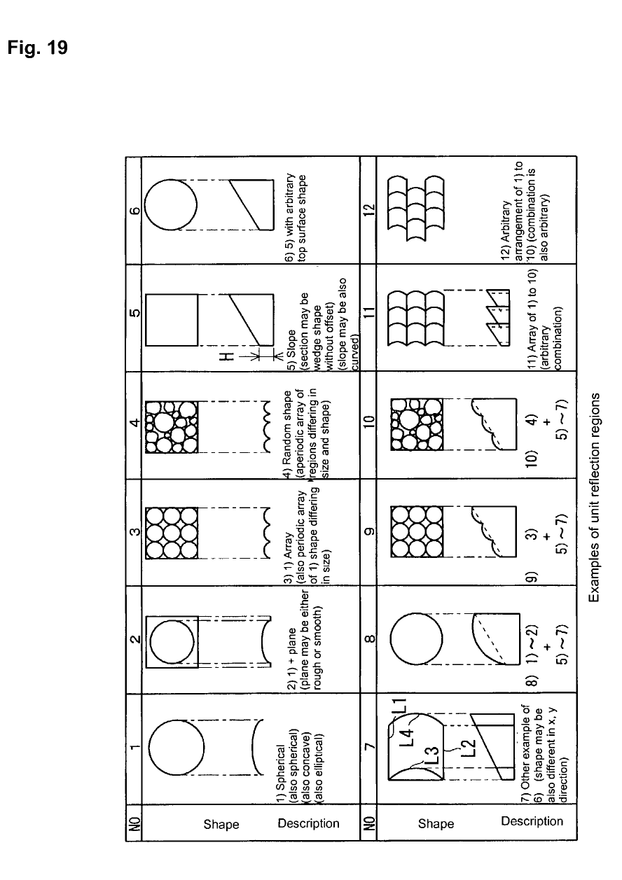

The range of forming the unit reflection regions should be an area in which the reflected light range of the unit reflection regions does not pass through the adjacent opening, in consideration of the incident angle of ambient light, light diffusion angle of unit reflection regions, reflection angle, and width of black matrix unit 2. (Modified examples) Examples of shape of unit reflection regions to be used in the embodiments are shown in FIG. 15.

The columns in FIG. 15 are composed of No., Shape, and Description. The column of No. refers to the number identifying the unit reflection region of each shape. The column of Shape is a plan view (top of drawing in each column) of shape of each unit reflection region and sectional view (bottom of drawing in each column). Unit reflection regions are explained below in the sequence of No. 1 to No. 12.

No. 1 is a spherical shape. Instead of spherical shape, unit reflection regions may be formed in part of convex surface or elliptical rotating element.

No. 2 is a unit reflection region of No. 1 assembled in a flat plane. The flat plane may be either rough or smooth.

No. 3 is an array of a plurality of unit reflection regions of No. 1. Unit reflection regions of No. 1 differing in size may be arrayed in a plurality.

No. 4 is an aperiodic (random) arrangement of unit reflection regions differing in size and shape.

No. 5 is a slope shape of unit reflection region, that is, rectangular parallelepiped (square column) is cut obliquely. In No. 5, “H” in bottom of drawing shows an offset from the reflection layer base part of the slope. By setting offset H =0, the unit reflection region may be formed like a wedge. The slope may be a curved surface.

No. 6 is an oblique cut section of circular column, instead of rectangular parallelepiped of No. 5. However, other shape than circular column (not circle in plan view), for example, column of triangular or polygonal section may be cut obliquely.

No. 7 is an oblique cut section of pattern of which plan view (sectional view) is surrounded with straight lines L1, L2, and curves L3, L4. That is, the right and left sides of the rectangular shape in plan view of No. 5 are formed in curved lines (corresponding two planes of square column are curved surfaces).

No. 8 is a combined shape of No. 1 or No. 2, with any one of No. 5 to No. 7. That is, convexor spherical surface is combined with a slope surface.

No. 9 is a combined shape of No. 3 with any one of No. 5 to No. 7. That is, an array of convex surfaces or an array of spherical surfaces is placed on a slope surface.

No. 10 is a combined shape of No. 4 with any one of No. 5 to No. 7. That is, an aperiodic array of convex surfaces or an aperiodic array of spherical surfaces is placed on a slope surface.

No. 11 is an array of plural shaped selected from shapes of No. 1 to No. 10. No. 12 is an array of No. 11 disposed with an offset in each line or row of array. In No. 11 or No. 12, if adjacent elements include concave and convex shapes (for example, unit reflection regions having the plan view shape of No. 7 are used as elements), the concave portions and convex portions may be engaged with each other.

(Application)

The reflective display of the embodiments may applied in, aside from displays of mobile phone or power-saving type radio devices, displays of portable information terminals such as electronic calendar, laptop computer, video camera, and television.

As described herein, according to the invention, by forming unit reflection regions of a nearly constant quantity beneath the pixel or the opening of each color of color filter, the quantity of emitted light from the opening is made uniform, and therefore lowering the visibility like moire pattern, roughness, uneven color or other phenomenon can be lessened.

What is claimed is:

1. A reflective display comprising a liquid crystal display, and a reflective plate for reflecting the light passing through said liquid crystal display,
wherein said liquid crystal display has plural openings,
said reflective plate has plural unit reflection regions, and
the array pitch r of the unit reflection regions and the array pitch p of the openings satisfy the relation of
r=p/m (where m is a natural number of 2 or more).

2. A reflective display comprising a liquid crystal display, a front light disposed ahead of said liquid crystal display for emitting light to the liquid crystal display, and a reflective plate for reflecting the light passing through said liquid crystal display,
wherein said liquid crystal display has plural openings,
said reflective plate has a plurality of first unit reflection regions reflecting the ambient light passing through the front light and liquid crystal display in a specified direction, and second unit reflection regions for reflecting the illuminating light emitted from the front light and passing through the liquid crystal display in a specified direction, and
the array pitches s1, s2 of the first and second unit reflection regions and the opening pitch p of the liquid crystal display satisfy the relations of
s1=p/n1
s2=p/n2 (where n1, n2 are natural numbers of 2 or more).

3. The reflective display of claim 1, wherein said openings are pixels of the image formed by the liquid crystal display.

4. The reflective display of claim2, wherein said openings are pixels of the image formed by the liquid crystal display.

5. The reflective display of claim 1, wherein said liquid crystal display has a color filter formed of display regions for plural colors, and said openings are monochromatic openings of said color filter.

6. The reflective display of claim 2, wherein said liquid crystal display has a color filter formed of display regions for plural colors, and said openings are monochromatic openings of said color filter.

7. The reflective display of claim 1, wherein said liquid crystal display has a black matrix unit, and regions not forming unit reflection regions are disposed in the regions on the reflective plate shielded by said black matrix unit.

8. The reflective display of claim 2, wherein said liquid crystal display has a black matrix unit, and regions not forming unit reflection regions are disposed in the regions on the reflective plate shielded by said black matrix unit.

9. The reflective display of claim 1, wherein the range of forming the unit reflection regions is limited by the unit reflection regions so that the light entering from a specified opening may be emitted only from the same opening.

10. The reflective display of claim 2, wherein the range of forming the unit reflection regions is limited by the unit reflection regions so that the light entering from a specified opening may be emitted only from the same opening.

11. An information appliance using a reflective display comprising:
a liquid crystal display having plural openings, and
a reflective plate having plural unit reflection regions for reflecting the light passing through said liquid crystal display,
wherein the array pitch r of the unit reflection regions and the array pitch p of the openings satisfy the relation of
r=p/m (where m is a natural number of 2 or more).

12. An information appliance using a reflective display comprising:
a liquid crystal display having plural openings,
a front light disposed ahead of said liquid crystal display for emitting light to the liquid crystal display, and
a reflective plate having a plurality of first unit reflection regions and second unit reflection regions each for reflecting the light passing through the liquid crystal display,
wherein the array pitches s1, s2 of said unit reflection regions and the array pitch p of said openings satisfy the relations of
s1=p/n1
s2=p/n2 (where n1, n2 are natural numbers of 2 or more).

13. A liquid crystal display method using a reflective display comprising:
a liquid crystal display having plural openings, and
a reflective plate having plural unit reflection regions,
wherein the array pitch r of the unit reflection regions and the array pitch p of the openings satisfy the relation of
r=p/m (where m is a natural number of 2 or more), and
an image is created by reflecting the light entering from the liquid crystal display by the unit reflection regions, and emitting to the front face from the liquid crystal display.

14. A liquid crystal display method using a reflective display comprising:
a liquid crystal display having plural openings,
a front light disposed ahead of said liquid crystal display for emitting light to the liquid crystal display, and
a reflective plate having a plurality of first unit reflection regions and second unit reflection regions each,
wherein the array pitches s1, s2 of said unit reflection regions and the opening pitch p of said liquid crystal display satisfy the relations of
s1=p/n1
s2=p/n2 (where n1, n2 are natural numbers of 2 or more), and
an image is created by reflecting the external light and the light from the front light in specified directions each by the first unit reflection regions and second unit reflection regions, and emitting to the front face from the liquid crystal display.
